(19) United States
(12) Patent Application Publication
(10) Pub. No.: US 2018/0120930 A1
(43) Pub. Date: May 3, 2018

(54) Use of Body-Area Network (BAN) as a Kinetic User Interface (KUI)

(71) Applicant: BRAGI GmbH, Munchen (DE)

(72) Inventor: Jake Berry Turner, Munchen (DE)

(73) Assignee: BRAGI GmbH, Munchen (DE)

(21) Appl. No.: 15/800,984

(22) Filed: Nov. 1, 2017

Related U.S. Application Data
(60) Provisional application No. 62/416,629, filed on Nov. 2, 2016.

(51) Int. Cl. G06F 3/01; H04W 4/00; H04R 1/10

(52) U.S. Cl. CPC G06F 3/011; H04R 1/1016; G06F 3/017; H04W 4/008

(57) ABSTRACT

In an embodiment of the present invention a body area network may have one or more of the following features: (a) a plurality of wearable electronic devices, which may have one or more of the following features: (i) a housing, (ii) a sensor operatively connected to the housing, wherein the sensor is configured to sense an excitation event; and (iii) a transceiver operatively connected to the sensor, wherein the transceiver is configured to receive a data signal encoding the excitation event from the sensor and transmit the data signal to a second transceiver disposed within a second wearable electronic device, (b) a processor disposed within the housing of at least one of the wearable electronic devices is configured to determine a kinetic user action associated with the excitation event from the data signal encoding of the excitation event, (c) a mobile device operatively coupled to at least one of the plurality of wearable electronic devices, (d) a data service operatively coupled to the mobile device, and (e) a network operatively coupled to the mobile device and the data service.

### PRIORITY STATEMENT

This application claims priority to U.S. Provisional Patent Application No. 62/416,629, titled Use of Body-Area Network (BAN) as a Kinetic User Interface (KUI), filed on Nov. 2, 2016, hereby incorporated by reference in its entirety.

### FIELD OF THE INVENTION

The present invention relates to electronic devices. Particularly, the present invention relates to wearable electronic devices. More particularly, but not exclusively, the present invention relates to networked wearable electronic devices.

### BACKGROUND

Wearable electronic device technology is intended to be used frequently while a user is active (e.g., walking, driving, sports, sleeping, etc.). Conventional wearable electronic device user interfaces (e.g., a mouse, touch interfaces, voice commands, etc.) may be difficult and/or impractical (e.g., double tapping a touch interface on a head-worn device while running, or talking while out-of-breath in a windy environment, etc.) when a user is performing tasks limiting their ability to use the electronic device. In this context conventional user interfaces can be ungainly and make the wearable electronic device useless or have diminished capacity during specific movement events.

One potential method of alleviating this problem is through the use of a kinetic user interface. Most people have excellent spatial ability when it comes to locating areas of their own body. People are very capable of locating regions of their bodies themselves without significant conscious effort even during kinetic scenarios (e.g., periods of significant motion, such as an athlete running or an elderly person walking). Using a kinetic user interface, a user may use an area of their body which may be more convenient than manually touching a wearable electronic device. What is then needed is a system and method of providing a kinetic user interface to allow a user to control one or more functions of a wearable electronic device regardless of where on the users body the user interfaces.

### SUMMARY

Therefore, it is a primary object, feature, or advantage of the present invention to improve over the state of the art.

In an embodiment of the present invention a body area network may have one or more of the following features: (a) a plurality of wearable electronic devices, which may have one or more of the following features: (i) a housing, (ii) a sensor operatively connected to the housing, wherein the sensor is configured to sense an excitation event; and (iii) a transceiver operatively connected to the sensor, wherein the transceiver is configured to receive a data signal encoding the excitation event from the sensor and transmit the data signal to a second transceiver disposed within a second wearable electronic device, (b) a processor disposed within the housing of at least one of the wearable electronic devices is configured to determine a kinetic user action associated with the excitation event from the data signal encoding of the excitation event, (c) a mobile device operatively coupled to at least one of the plurality of wearable electronic devices, (d) a data service operatively coupled to the mobile device, and (e) a network operatively coupled to the mobile device and the data service.

In an embodiment of the present invention at least two wearable electronic devices may have one or more of the following features: (a) a housing, (b) a sensor operatively connected to the housing, wherein the sensor is configured to sense an excitation event and convert the excitation event into a data signal, (c) a transceiver operatively connected to the sensor, wherein the transceiver is configured to transmit or receive the data signal, (d) a processor disposed operatively coupled to the transceiver, wherein the processor is programmed to determine whether a kinetic user action occurred based upon the data signals, and (e) a memory device storing an algorithm used by the processor to determine whether the kinetic user action occurred.

In an embodiment of the present invention, a method for creating a body area network may have one of more of the following steps: (a) sensing an excitation event at a sensor operatively connected to a plurality of wearable electronic devices, (b) converting the excitation event into a data signal, (c) communicating the data signal to a processor disposed within the plurality of wearable electronic devices, (d) comparing data encoded in the data signal with user data stored in a memory device operatively connected to the plurality of wearable electronic devices using the processor to determine if the excitation event is associated with a kinetic user action, (e) executing a command associated with the kinetic user action if the excitation event is determined by the processor to be the kinetic user action, (f) transmitting a signal encoding a command associated with the kinetic user action to at least one wearable electronic device via a transceiver operatively connected to the plurality of wearable electronic devices if the processor determines from the comparison the excitation event is associated with the kinetic user action, (g) storing the data encoded in the data signal in the memory device if the data associated with the excitation event is associated with a kinetic user action by a user, (h) querying a user if the data encoded in the data signal is associated with the kinetic user action, and (i) modifying a functionality of the set of wearable devices in response to the signal encoding the command associated with the kinetic user action.

One or more of these and/or other objects, features, or advantages of the present invention will become apparent from the specification and claims follow. No single embodiment need provide each and every object, feature, or advantage. Different embodiments may have different objects, features, or advantages. Therefore, the present invention is not to be limited to or by an objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIG. 1 illustrates a block diagram of a plurality of wearable electronic devices in accordance with an embodiment of the present invention;

FIG. 2 illustrates a plurality of wearable electronic devices in another embodiment of the present invention;

FIG. 3 illustrates a wearable electronic device and its relationship with a network in accordance with an embodiment of the present invention;

FIG. 4 illustrates a pair of wireless earpieces in accordance with an embodiment of the present invention;

FIG. 5 illustrates a right earpiece and its relationship to an ear in accordance with an embodiment of the present invention;

FIG. 6 illustrates a flowchart of a method for determining an intent from a user action using a set of wearable electronic devices in accordance with an embodiment of the present invention; and

FIG. 7 is a block diagram illustrating a plurality of difference devices in a body area network in accordance with an embodiment of the present invention; AND

FIG. 8 is a pictorial representation of a BAN as a KUI in accordance with an embodiment of the present invention.

### DETAILED DESCRIPTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of body area networks and kinetic user interfaces, it is fully contemplated embodiments of the present invention could be used in most any electronic communications device without departing from the spirit of the invention.

It is an object, feature, or advantage of the present invention to provide a kinetic user interface where kinetic user actions may be sensed. Another further object, feature, or advantage of the present invention to provide a kinetic user interface which may be used by earpieces or other wearable devices. A further object, feature, or advantage is to provide a user interface which is intuitive and easy to use. Yet another object, feature, or advantage is to provide a kinetic user interface which is reliable. A further object, feature, or advantage is to use a body area network.

In one embodiment, a plurality of wearable electronic devices has a housing and a sensor operatively connected to the housing. The sensor is configured to sense a user action and convert the user action into a data signal encoding the user action. A transceiver can be operatively connected to the housing and the sensor and configured to receive the data signal encoding the user action from the sensor and transmit the data signal encoding the user action to a second transceiver. The second transceiver can be disposed within the housing of a second wearable electronic device out of the plurality of electronic devices. A processor disposed within the housing of one of the wearable electronic devices is configured to determine an intent associated with the user action from the data signal encoding the user action.

One or more of the following features may be included. The processor may be disposed within the housing of the second wearable electronic device. Each sensor may be an inertial sensor. The transceiver may be a near field magnetic induction transceiver. Each wearable electronic device may have a processor. A microphone may be operatively connected to the housing and the processor of one or all of the wearable electronic devices. A memory device may be operatively connected to the housing and the processor. The processor may execute a function associated with the intent.

In another embodiment, a pair of earpieces having a left earpiece and a right earpiece has an earpiece housing and a sensor operatively connected to the earpiece housing. The sensor is configured to sense a user action and convert the user action into one or more data signals. A transceiver can be operatively connected to the sensor and the earpiece housing and configured to transmit or receive the data signals. A processor, disposed within the earpiece housing and operatively connected to the sensor and the transceiver is programmed to determine an intent from the data signals.

One or more of the following features may be included. Each sensor may be an inertial sensor. Each transceiver may be a near field magnetic induction transceiver. The left earpiece may further comprise a memory device operatively connected to the processor of the left earpiece. The right earpiece further comprises a memory device operatively connected to the processor of the right earpiece. An algorithm stored on the memory device of the left earpiece may be used by the processor of the left earpiece to determine the intent associated with the user action. An algorithm stored on the memory device of the right earpiece may be used by the processor of the right earpiece to determine the intent associated with the user action. The processor may execute a function associated with the intent.

In another embodiment, a method for determining an intent from a user action using a set of wearable electronic devices can include sensing the user action at a sensor operatively connected to the set of wearable electronic devices. The user action is converted into a data signal. The data signal is communicated to a processor disposed within the set of wearable electronic devices. Data encoded in the data signal is compared with user data stored in a memory device operatively connected to the set of wearable electronic devices using the processor disposed within the set of electronic devices to determine if the user action is associated with the intent. A command is executed associated with the intent if the user action substantially matches the intent.

One or more of the following features may be included. Transmitting a signal encoding a command associated with the intent to at least one wearable electronic device via a transceiver operatively connected to the set of wearable electronic devices if the processor determines from the comparison of the data with the user data, the user action is associated with the intent. The data encoded in the data signal in the memory device may be stored if the data associated with the user action is not associated with an intent in the memory device. A user may be queried if the data encoded in the data signal is not associated with the intent. A functionality of the set of wearable devices may be modified in response to the signal encoding the command associated with the user intent.

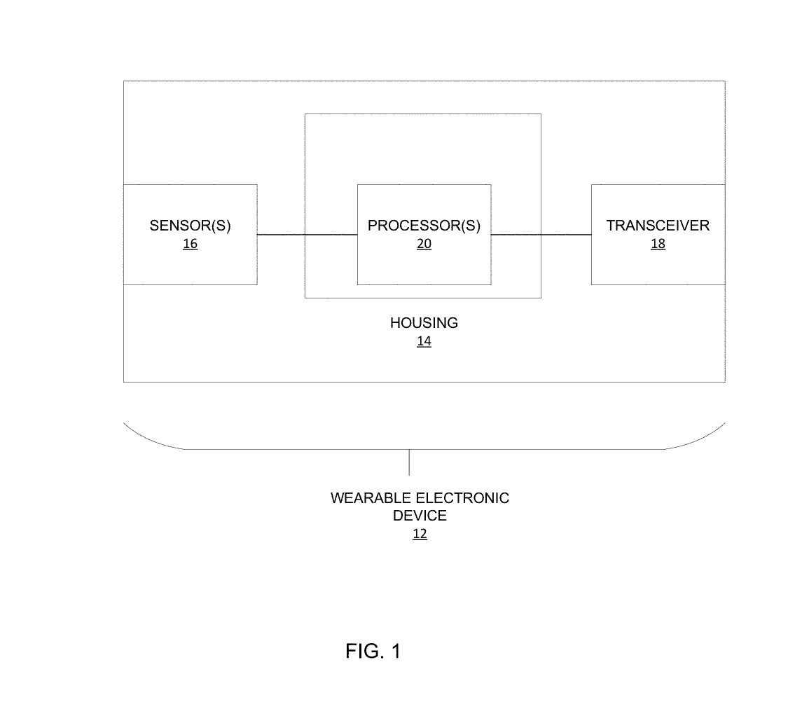

FIG. 1 shows a block diagram of one embodiment of a plurality of wearable electronic devices 12. For the purposes of embodiments of the present invention, wearable electronic devices can include, but are not limited to: sensors, electrodes, glasses, contacts, dental implants, head bands, earpieces, jewelry, clothing with implants, implantable devices, shoes with implants, watches, mobile phones and tablets, hairpieces, mouthpieces, etc. Each wearable electronic device 12 has a housing 14. A sensor(s) 16 can be operatively connected to the housing 14 and configured to sense a kinetic user action and convert the user action into a data signal encoding. A kinetic user action (hereinafter referred to as KUA) can include most any type of action to indicate a desired action. Such as, tapping or touching of the skin or body, taping or stomping of the foot, nodding of the heard, blinking of the eyes, raising and lowing appendages including the phalanges, and flexing and releasing of any musculature. A transceiver 18 can be operatively connected to the housing 14 and the sensor 16. The transceiver 18 is configured to receive the data signal encoding the KUA by the sensor 16 and transmit the data signal encoding the KUA. A processor 20 can be disposed within the housing 14 of one of the wearable electronic devices of the plurality of wearable electronic devices 12. The processor 20 can be configured to determine an intent from the data signal encoding the KUA.

The housing 14 of each wearable electronic device 12 may be composed of any material or combination of materials, such as metals, metal alloys, plastics, or other polymers, having substantial deformation resistance. For example, if one of the wearable electronic devices 12 is dropped by a user, the housing 14 may transfer the energy received from the surface impact throughout the surface of the housing in order to minimize any potential damage to the internal components of the wearable electronic device. In addition, the housing 14 may be capable of a degree of flexibility in order to facilitate energy absorbance if one or more forces is applied to one of the wearable electronic devices 12. For example, if an object is dropped on one of the wearable electronic devices 12, the housing 14 may bend in order to absorb the energy from the impact so the wearable electronic device components are not affected. The flexibility of the housing 14 should not, however, be flexible to the point where one or more components of the wearable electronic device become dislodged or otherwise rendered non-functional if one or more forces is applied. In one embodiment, the housing 14 is formed from one or more layers or structures of plastic, polymers, metals, graphene, composites or other materials or combinations of materials suitable for personal use by a user.

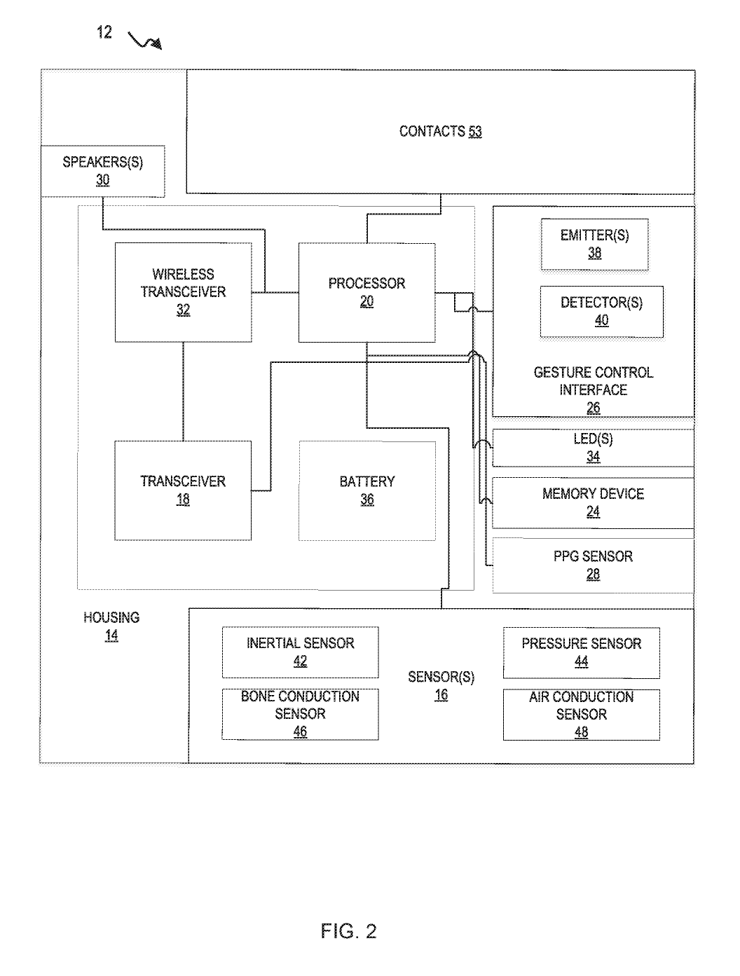

A sensor 16 may be operatively connected to a housing 14 of a wearable electronic device 12 and may be configured to sense a KUA and convert the KUA into a data signal encoding the user action. The sensor 16 may be an inertial sensor such as a MEMS gyroscope 42 (FIG. 2), an electronic accelerometer, or an electronic magnetometer, a PPG sensor 28 (FIG. 2), an EMG sensor, or even a bone or air conduction sensor 46 & 48 (FIG. 2). For example, if the sensor is a MEMS gyroscope 42, a user action such as a tap on the cheek may vibrate one or more proof masses (which may include tuning forks, wheels, piezoelectric materials, cantilevered beams, or a wine-glass resonator) in the gyroscope creating a Coriolis force in each proof mass. This may cause a change in the capacitance between one or more proof masses and another element of the sensor 16 or the wearable electronic device 12, creating one or more currents. Each current may be correlated with a change in a physical parameter of the sensor, which may be used as data signals. The data signals may be analog or digital, and may be amplified or attenuated by an amplifier prior to reception by a processor or transceiver.

A transceiver 18 may be operatively connected to a housing 14 of a wearable electronic device 12. The transceiver 18 may receive the data signals encoding the KUA from the sensor 16 and may be configured to transmit the data signals to a second transceiver disposed within the housing of a second electronic device. The data signals encoding the KUA may comprise a current or voltage profile encoded by the sensor 16 into a data signal transmitted to other transceivers housed in other wearable electronic devices of the plurality of wearable electronic devices 12. The data signals may also encode a current, a voltage, a position, an angular velocity or an acceleration profile encoded as a data signal by a processor and communicated to the transceiver 18.

The transceiver 18 is a component comprising both a transmitter and receiver which may be combined and share common circuitry on a single housing 14. The transceiver 18 may communicate utilizing Bluetooth, near-field magnetic induction (NFMI), Wi-Fi, ZigBee, Ant+, near field communications, wireless USB, infrared, mobile body area networks, ultra-wideband communications, cellular (e.g., 3G, 4G, 5G, PCS, GSM, etc.) or other suitable radio frequency standards, networks, protocols or communications. The transceiver 18 may also be a hybrid transceiver supporting a number of different communications, such as NFMI communications between the wearable electronic device 12 and the Bluetooth communications with a cell phone. For example, the transceiver 18 may communicate with a wireless device or other systems utilizing wired interfaces (e.g., wires, traces, etc.), NFC or Bluetooth communications. Further, transceiver 18 can communicate with Body Area Network (hereinafter referred to as BAN) 300 utilizing the communications protocols listed in detail above.

A processor 20 may be disposed within the housing 14 of a wearable electronic device of the plurality of wearable electronic devices 12. The processor 20 may be configured to determine an intent associated with the user action from the data signal encoding the KUA. The data signal may encode a current profile, wherein the current profile consists of two sets of data, time and the current of the sensor 16, which sensed the KUA. The data signal may encode a voltage profile, wherein the voltage profile consists of two sets of data, time and the voltage of the sensor 16, which sensed the KUA. The data signal may encode a profile of another physical parameter capable of being associated with the intent of the user's KUA. The processor 20 may determine the intent by comparing data encoded in the data signal with data in a memory device 24 (FIG. 2) operatively connected to the wearable electronic device the processor 20 is housed in. The data stored in the memory device 24 may comprise a current profile known to be associated with a tap on the right cheek, which may be compared by the processor 20 to the data encoded in the data signal. If a statistical algorithm performed on the two datasets by the processor 20 suggests there is, say, a 95% certainty the datasets are related, then the processor 20 may instruct one or more components of the wearable electronic device to execute an action associated with the user intent. The action may be to turn the electronic device 12 on or off, access a menu to select a piece of media to listen to, access a fitness program, access volume controls or other functions which may be associated with a wearable electronic device.

The processor 20 is the logic controls for the operation and functionality of the wearable devices 12. The processor 20 may include circuitry, chips, and other digital logic. The processor 20 may also include programs, scripts and instructions, which may be implemented to operate the processor 20. The processor 20 may represent hardware, software, firmware or any combination thereof. In one embodiment, the processor 20 may include one or more processors. The processor 20 may also represent an application specific integrated circuit (ASIC), system-on-a-chip (SOC) or field programmable gate array (FPGA). The processor 20 may utilize information from the sensors 42, 44, 46, 48 and 28 to determine the biometric information, data and readings of the user. The processor 20 may utilize this information and other criteria to inform the user of the associated biometrics (e.g., audibly, through an application of a connected device, tactilely, etc.). Similarly, the processor 20 may process inputs from contacts 53 to determine a KUA on wearable electronics device 12. The processor 20 may determine how KUA's are communicated based on the ear biometrics and structure. Information, such as shape, size, reflectance, impedance, attenuation, perceived volume, perceived frequency response, perceived performance and other factors may be utilized.

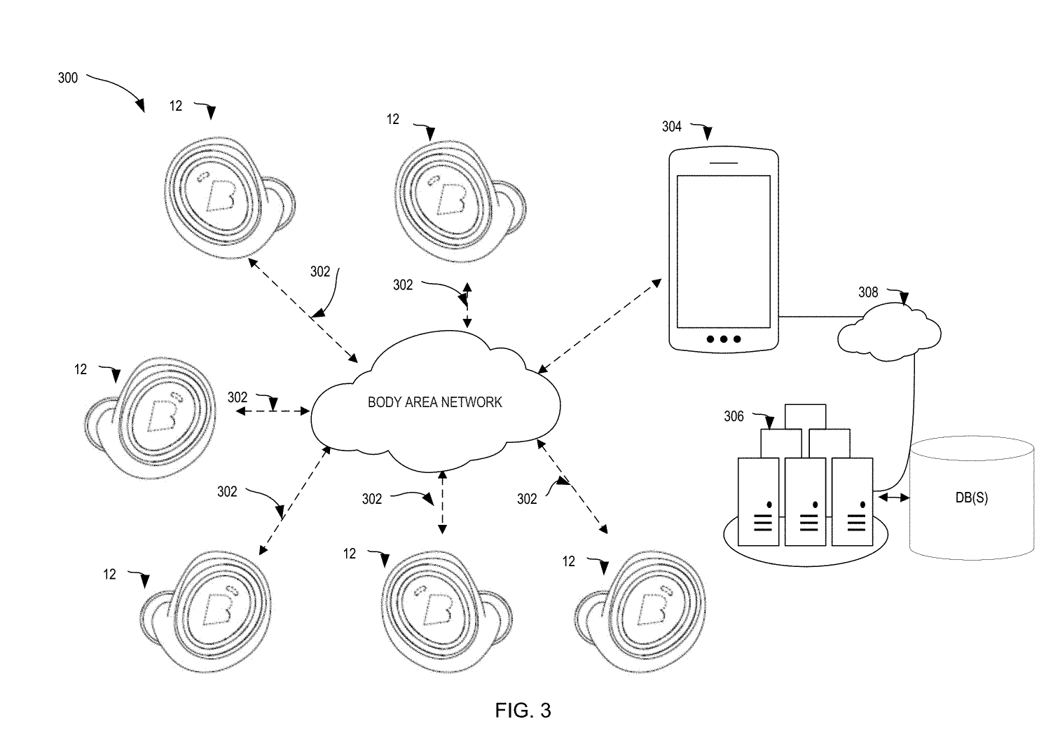

In one embodiment, the processor 20 may utilize an iterative process of adjusting volume and frequencies until user approved settings are reached. For example, the user may nod her head when the amplitude is at a desired level and then say stop to when the frequency levels (e.g., high, mid-range, low, etc.) of sample audio have reached desired levels. These settings may be saved for subsequent usage when the user is wearing the wearable electronic device 12. The user may provide feedback, commands or instructions through the user interface (e.g., voice (bone or air conduction sensor 46 & 48), tactile, motion, gesture control 26, or other input). In another embodiment, the processor 20 may communicate with another external wireless device (e.g., smart phone, BAN 300 (FIG. 3)) executing an application which receives KUA from the user for adjusting the performance of the wearable electronic device 12. In one embodiment, the application may recommend how the wearable electronic device 12 may be adjusted by the user for better performance. The application may also allow the user to adjust the performance and orientation of the wearable electronic device 12 (e.g., executing a program for tuning performance based on questions asked of the user and responses given back via the user interface).

The processor 20 may also process KUA to determine commands implemented by the wearable electronics device 12 or sent to the wearable electronics device 121 through the transceiver 18. The user input may be determined by the sensors 28, 42, 44, 46 and 48 to determine specific actions to be taken. In one embodiment, the processor 20 may implement a macro allowing the user to associate KUA as sensed by the sensors 28, 42, 44, 46 and 48 with commands. Similarly, the processor 20 may utilize measurements from the contacts 53 to adjust the various systems of the wearable electronics device 12 such as the volume, speaker orientation, frequency utilization, and so forth.

In one embodiment, the KUA profile or KUA response associated with the user and the wearable electronics device 12 may be utilized by the processor 20 to adjust the performance of one or more wearable electronics device 12. For example, the contacts 53 and other sensors 28, 42, 44, 46 and 48 of the wearable electronics device 12 may be utilized to determine the KUA profile or KUA response associated with the user and the wearable electronics device 12. In one embodiment, the processor 20 may associate user profiles or settings with specific users. For example, KUA's and KUA thresholds of acceptance, orientation, amplitude levels, frequency responses for audible signals and so forth may be saved.

In one embodiment, the processor 20 is circuitry or logic enabled to control execution of a set of instructions. The processor 20 may be one or more microprocessors, digital signal processors, application-specific integrated circuits (ASIC), central processing units or other devices suitable for controlling an electronic device including one or more hardware and software elements, executing software, instructions, programs, and applications, converting and processing signals and information and performing other related tasks. The processor may be a single chip or integrated with other computing or communications components.

FIG. 2 illustrates a second embodiment of the plurality of wearable electronic devices 12. In addition to the elements described in FIG. 1, one or more of the wearable electronic devices of the plurality of wearable electronic devices 12 may further comprise one or more bone or air conduction sensors 46 & 48, a memory device 24, a gesture interface 26, a PPG sensor 28, a speaker 30, a wireless transceiver 32, LEDs 34 and a battery 36. The housing 14, the sensor 16, the transceiver 18, and the processor 20 perform the same functions as outlined in FIG. 1, and the plurality of wearable electronic devices 12 may comprise more than one processor 20.

A bone or air conduction sensors 46 & 48 may be operatively connected to a housing 14 and may be configured to sense a voice command or to sense one or more sounds generated by the user or by one or more objects in operative contact with the user possibly used in conjunction with sensor readings by one or more sensors 16 or a PPG sensor 28. For example, if a microphone picks up the snapping sound of fingers, the sounds may be used by a processor 20 along with one or more sensor 16 readings or PPG sensor 28 readings to determine if the snapping of fingers is associated with an intent of the user. The user may also issue a voice command to one or more of the wearable electronic devise 12 to control, change or modify one or more of the functions of one of the wearable electronic device 12.

A memory device 24 may be operatively connected to the housing 14 and may have user data associated with an intent stored within and may also have one or more algorithms stored within possibly used to determine if one or more pieces of data associated with a KUA are related to an intent of the user. In addition, the memory device 24 may store data or information regarding other components of the plurality of wearable electronic devices 12. For example, the memory device 24 may store data or information derived from signals received from one of the transceivers 18 or the wireless transceiver 32, data or information regarding sensor readings unrelated to ascertaining a user intent from one or more of the sensors 16 or one or more of the PPG sensors 28, algorithms governing command protocols related to the gesture interface 26 or algorithms governing LED 34 protocols. The aforementioned list is non-exclusive.

The memory 24 is a hardware component, device, or recording media configured to store data for subsequent retrieval or access at a later time. The memory 24 may be static or dynamic memory. The memory 24 may include a hard disk, random access memory, cache, removable media drive, mass storage, or configuration suitable as storage for data, instructions and information. In one embodiment, the memory 24 and the processor 20 may be integrated. The memory 24 may use any type of volatile or non-volatile storage techniques and mediums. The memory 24 may store information related to the status of a user, such as KUAs used previously, wearable electronic device 12 and other peripherals, such as another wearable electronic device, smart case for the wearable electronic device 12, smart watch, BAN 300 and so forth. In one embodiment, the memory 24 may display instructions or programs for controlling the gesture control interface 26 including one or more LEDs or other light emitting components 38, speakers 30, tactile generators (e.g., vibrator) and so forth. The memory 24 may also store the user input information associated with each command, such as a KUA. The memory 24 may also store default, historical or user specified information regarding settings, configuration or performance of the wearable electronics device 12 (and components thereof) based on the user contact with contacts 53 and/or gesture control interface 26.

The memory 24 may store settings and profiles associated with users, speaker settings (e.g., position, orientation, amplitude, frequency responses, etc.) and other information and data may be utilized to operate the wearable electronics device 12. The wearable electronics device 12 may also utilize biometric information to identify the user so settings and profiles may be associated with the user. In one embodiment, the memory 24 may include a database of applicable information and settings. In one embodiment, applicable KUA information received from the contacts 53 may be looked up from the memory 24 to automatically implement associated settings and profiles.

A gesture interface 26 may be operatively connected to the housing 14 and may be configured to allow a user to control one or more functions of one or more of the plurality of wearable electronic devices 12. The gesture interface 26 may include at least one emitter 38 and at least one detector 40 to detect gestures from either the user, a third-party, an instrument, or a combination of the aforementioned and communicate the gesture to the processor 20. The gestures possibly used with the gesture interface 26 to control a wearable electronic device 12 include, without limitation, touching, tapping, swiping, use of an instrument, or any combination of the aforementioned gestures. Touching gestures used to control the wearable electronic device 12 may be of any duration and may include the touching of areas not part of the gesture interface 26. Tapping gestures used to control the wearable electronic device 12 may include any number of taps and need not be brief. Swiping gestures used to control the wearable electronic device 12 may include a single swipe, a swipe changing direction at least once, a swipe with a time delay, a plurality of swipes, or any combination of the aforementioned. An instrument used to control the wearable electronic device 12 may be electronic, biochemical or mechanical, and may interface with the gesture interface 26 either physically or electromagnetically.

The gesture interface 26 is a hardware interface for receiving commands, instructions or input through the touch (haptics) of the user, voice commands (e.g., through bone or air conduction sensors 46 & 48) or pre-defined motions (i.e., KUAs). The gesture interface 26 may be utilized to control the other functions of the wearable electronic device 12. The gesture interface 26 may include an LED array, one or more touch sensitive buttons, or portions, a miniature screen or display or other input/output components. The gesture interface 26 may be controlled by the user or based on commands received from an external device, a linked wireless device and/or BAN 300.

In one embodiment, the user may provide feedback by tapping the gesture interface 26 once, twice, three times or any number of times. Similarly, a swiping motion may be utilized across or in front of the gesture interface 26 to implement a predefined action. Swiping motions in any number of directions may be associated with specific activities, such as play music, pause, fast forward, rewind, activate a digital assistant (e.g., Siri, Cortana, smart assistant, etc.), end a phone call, make a phone call and so forth. The swiping motions may also be utilized to control actions and functionality of the wearable electronic device 12 or other external devices (e.g., smart television, camera array, smart watch, etc.). The user may also provide user input by moving her head in a particular direction or motion or based on the user's position or location. For example, the user may utilize voice commands, head gestures or touch commands to change the content being presented audibly. The gesture interface 26 may include a camera or other sensors for sensing motions, gestures, or symbols provided as feedback or instructions.

Although shown as part of the gesture interface 26, contacts 53 may also be integrated with other components or subsystems of the wearable electronic device 12, such as the sensors 16 & 28. The contacts 53 may detect physical contact or interaction with the user. In another embodiment, the contacts 53 may detect the proximity of the user's skin or tissues to the contacts 53 to determine if and to what extent a KUA occur.

In another embodiment, the contacts 53 may be configured to provide user feedback. For example, the contacts 53 may be utilized to send tiny electrical pulses to the user. For example, a current may be communicated between different portions of the wearable electronic device 12. For example, current expressed inferior to the wearable electronic device 12 may indicate a text message has been received, current expressed superior to the wireless electronic device 12 may indicate the user's heart rate has exceeded a specified threshold, and a current expressed proximate the skin may indicate a call is incoming from a connected wireless device.

In another embodiment, the contacts 53 may be micro air emitters which similarly provide feedback or communications to the user. The micro air emitters may utilize actuators, arms, or miniaturized pumps to generate tiny puffs of air/gas provide feedback to the user. In yet another embodiment, the contacts 53 may be utilized to analyze fluid or tissue analysis from the user. The samples may be utilized to determine biometrics (e.g., glucose levels, adrenaline, thyroid levels, hormone levels, etc.).

A PPG sensor 28 may be operatively connected to the housing 14 and may be configured to sense one or more volumetric measurements related to blood flow or one or more of a user's organs using optical techniques. For example, a PPG sensor 28 positioned proximate to a surface of a user's extremity such as a finger, arm, or leg may transmit light toward the surface of the user's extremity and sense the amount of light reflected from the surface and tissues beneath the surface. The amount of reflected light received by the PPG sensor 28 may be used to determine one or more volumetric changes in the user's extremity. The measured volumetric changes may also be used in conjunction with KUA sensed by one or more sensors 16 to determine an intent associated with a user. For example, if a PPG sensor 28 does not measure a change in volumetric pressure in the extremity used to perform a user action, the PPG sensor 28 may communicate a signal to the processor 20 to instruct the processor 20 not to associate the user action with an intent if a data signal encoding a user action from a sensor 16 is from the same extremity or area of the body the volumetric pressure reading was taken. The PPG sensor 28 may also be used to measure a heart rate which may be used in conjunction with a user action to determine if a user action is associated with an intent. Alternatively, to a PPG, a heart rate sensor can be used in place of a PPG sensor.

A speaker 30 may be operatively connected to the housing 14 and may communicate one or more pieces of media or information if desired by the user. For example, if a user snaps his fingers twice to instruct a wearable electronic device to switch to a new song during a jogging workout, one or more sensors 16 may sense the finger snaps as minute vibrations and communicate the current or voltage changes to the processor 20 which may associate the finger snaps with an intent to switch to a new song and instruct the speaker 30 to communicate the new song to the user. intimate

A wireless transceiver 32 may be disposed within the housing 14 and may receive signals from or transmit signals to an electronic device outside the wearable electronic device 12 network 300. The signals received from or transmitted by the wireless transceiver 32 may encode data or information related to media or information related to news, current events, or entertainment, information related to the health of a user or a third party, information regarding the location of a user or third party, or the functioning of a wearable electronic device 12. For example, if a user desires to download data to a memory device 24 from a mobile device or a laptop, the user may perform an action which may be sensed by a sensor 16 and/or contact 53 and communicated directly via a wireless transceiver 32 or indirectly via a transceiver 18 to another wearable electronic device 12 which has a wireless transceiver 32 to the mobile device or laptop instructing the mobile device or laptop to download the data to the memory device 24. More than one signal may be received from or transmitted by the wireless transceiver 32.

One or more LEDs 34 may be operatively connected to the housing 14 and may be configured to provide information concerning the wearable electronic device 12. For example, the processor 20 may communicate a signal encoding information related to the current time, the battery life of the wearable electronic device 12, the status of an operation of another wearable electronic device, or another wearable device function, wherein the signal is decoded and displayed by the LEDs 34. For example, the processor 20 may communicate a signal encoding the status of the energy level of a wearable electronic device, wherein the energy level may be decoded by LEDs 34 as a blinking light, wherein a green light may represent a substantial level of battery life, a yellow light may represent an intermediate level of battery life, and a red light may represent a limited amount of battery life, and a blinking red light may represent a critical level of battery life requiring immediate attention. In addition, the battery life may be represented by the LEDs 34 as a percentage of battery life remaining or may be represented by an energy bar comprising one or more LEDs wherein the number of illuminated LEDs represents the amount of battery life remaining in the wearable electronic device. The LEDs 34 may be located in any area on a wearable electronic device suitable for viewing by the user or a third party and may consist of as few as one diode which may be provided in combination with a light guide. In addition, the LEDs 34 need not have a minimum luminescence.

A battery 36 may be operatively connected to all of the components within a wearable electronic device 12. The battery 36 should provide enough power to operate the wearable electronic device 12 for a reasonable duration of time. The battery 36 may be of any type suitable for powering the wearable electronic device 12. However, the battery 36 need not be present in the wearable electronic device 12. Alternative battery-less power sources, such as sensors configured to receive energy from radio waves (all of which are operatively connected to one or more wearable electronic devices 12) may be used to power a wearable electronic device 12 in lieu of a battery 36. The battery 36 is a power storage device configured to power the wearable electronics device 12. In other embodiments, the battery 36 may represent a fuel cell, thermal electric generator, piezo electric charger, solar charger, ultra-capacitor or other existing or developing power storage technologies.

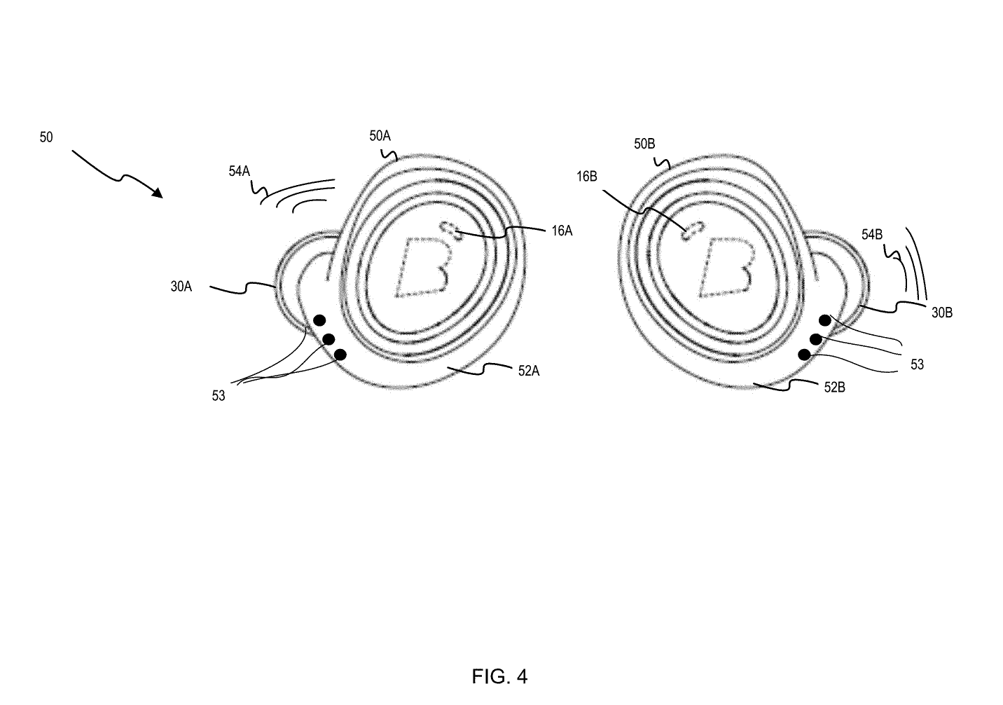

FIG. 4 illustrates a pair of earpieces 50, in another embodiment of the invention. The following discussion of earpieces 50 provides a discussion of wearable electronic devices in accordance with the present invention. However, while only a discussion of wireless earpieces 50 is presented, it is fully contemplated and understood most any wearable electronic device could be substituted for wireless earpieces 50 without departing from the spirit of the invention as discussed in great detail above. Further, it is fully contemplated all substitute wearable electronics devices could have a structure similar to the below described wireless earpieces 50. While the inventor is discussing the present invention in pictorial representation to wireless earpieces 50, the inventor fully contemplates most any wearable electronics device could be substituted for wireless earpieces without departing from the spirit of the invention.

The pair of earpieces 50 includes a left earpiece 50A and a right earpiece 50B. The left earpiece 50A has a left housing 52A. The right earpiece 50B has a right housing 52B. The left earpiece 50A and the right earpiece 50B may be configured to fit on, at, or within a user's external auditory canal and may be configured to substantially minimize or completely eliminate external sound capable of reaching the tympanic membranes. The housings 52A and 52B may be composed of any material with substantial deformation resistance and may also be configured to be soundproof or waterproof. A sensor 16A is shown on the left earpiece 50A and a sensor 16B is shown on the right earpiece 50B. The sensors 16A and 16B may be located anywhere on the left earpiece 50A and the right earpiece 50B respectively and may comprise an inertial sensor such as a MEMS gyroscope or an electronic accelerometer, a PPG sensor, an EMG sensor, or even a microphone. More than one sensor may be found on either earpiece, and the sensors may differ on either earpiece. For example, left earpiece 50A may have a MEMS gyroscope and a microphone, whereas the right earpiece 50B may have a MEMS gyroscope, an electronic accelerometer, and a PPG sensor. Speakers 30A and 30B may be configured to communicate sounds 54A and 54B. The sounds 54A and 54B may be communicated to the user, a third party, or another entity capable of receiving the communicated sounds. The sounds may comprise functions related to an intent of the user, media or information desired by the user, or information or instructions automatically communicated to the user in response to one or more programs or algorithms executed by a processor 20. Speakers 30A and 30B may also be configured to short out if the decibel level of the sounds 54A and 54B exceeds a certain decibel threshold, which may be preset or programmed by the user or a third party.

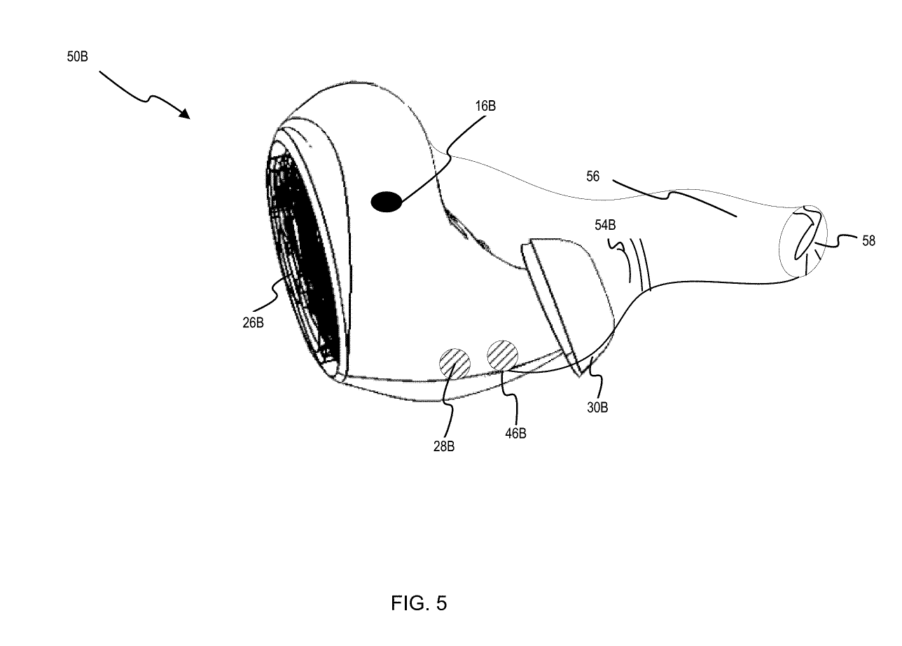

FIG. 5 illustrates a side view of the right earpiece 50B and its relationship to a user's ear. The right earpiece 50B may be configured to facilitate the transmission of the sound 54B from the speaker 30B to a user's tympanic membrane 58 and the distance between the speaker 30B and the user's tympanic membrane 58 may be any distance sufficient to facilitate transmission of the sound 54B to the user's tympanic membrane 58. There is a gesture interface 26B shown on the exterior of the earpiece. The gesture interface 26B may provide for gesture control by the user or a third party such as by tapping or swiping across the gesture interface 26B, tapping or swiping across another portion of the right earpiece 50B, providing a gesture not involving the touching of the gesture interface 26B or another part of the right earpiece 50B, or through the use of an instrument configured to interact with the gesture interface 26B. In addition, one or more sensors 16B may be positioned on the right earpiece 50B to allow for sensing of user actions unrelated to gestures. For example, one sensor 16B, which may be a MEMS gyroscope, possibly positioned on the right earpiece 50B to sense one or more physical movements which may be communicated to a processor within the right earpiece 50B for use in determining whether the user action is associated with an intent related to the right earpiece 50B. In addition, a PPG sensor 28B may be positioned at any location facing either an outer surface of the user or the inside of the user's external auditory canal 56 and may be used either independently or in conjunction with sensor readings from one or more of the sensors 16B. For example, the PPG sensor 28 may sense absorption changes due to volumetric changes in blood flow related to a user's heart rate and communicate the readings to a processor, which may use the PPG sensor readings along with other sensor readings to determine whether a user action associated with the PPG sensor reading may be associated with an intent. Finally, a bone conduction microphone may be positioned near the temporal bone of the user's skull in order to sense a sound from a part of the user's body or to sense one or more sounds before the sounds reach one of the microphones due to the fact sound travels much faster through bone and tissue than air. For example, the bone conduction microphone may be used in conjunction with one or more microphones to determine whether a vocal sound emanated from the user. This may be determined by comparing sounds received by the microphones versus the sounds received by the bone conduction microphone using a processor and determining a vocal sound emanated from the user if the bone conduction microphone received a vocal sound before the microphone.

FIG. 3 illustrates a body area network 300 created by the plurality of wearable electronic devices 12. Each wearable electronic device 12 may be located at an area of the user's body capable of sensing a physical action performed by the user. Such physical actions may include one or more actions related to the user's hands, fingers, thumbs, arms, elbows, shoulders, eyes, mouth, tongue, stomach, hips, knees, feet, or any other part of the body reasonably used as a KUA. Each wearable electronic device 12 may have a processor 20 disposed within the housing which may be used to determine if sensor readings potentially associated with a KUA are further associated with an intent using one or more algorithms. Each wearable electronic device 12 may also transmit sensor readings (302) to one or more wearable electronic devices 12 for processing. Each wearable electronic device 12 may be further connected to a mobile phone 304, a tablet, or one or more data servers 306 through a network 308. The network 308 may be the Internet, a Local Area Network, or a Wide Area Network, and the network 308 may comprise one or more routers, one or more communications towers, or one or more Wi-Fi hotspots, and signals transmitted from or received by one of the wearable electronic devices 12 may travel through one or more devices connected to the network 308 before reaching their intended destination. For example, if a user wishes to download data regarding relationships between measured sensor readings and the intents associated with the measured sensor readings, the user may instruct one of the wearable electronic devices 12 to transmit a signal encoding instructions to the network 308 to send the data to one or more wearable electronic devices 12, which may travel through a communications tower and one or more routers before arriving at the mobile device 304, tablet, or electronic device which contains the data regarding relationships between measured sensor readings and the intents associated with the measured sensor readings. The signal may be transmitted continuously or discretely, and the data may not be sent to a wearable electronic device 12 if one or more technical errors are encountered.

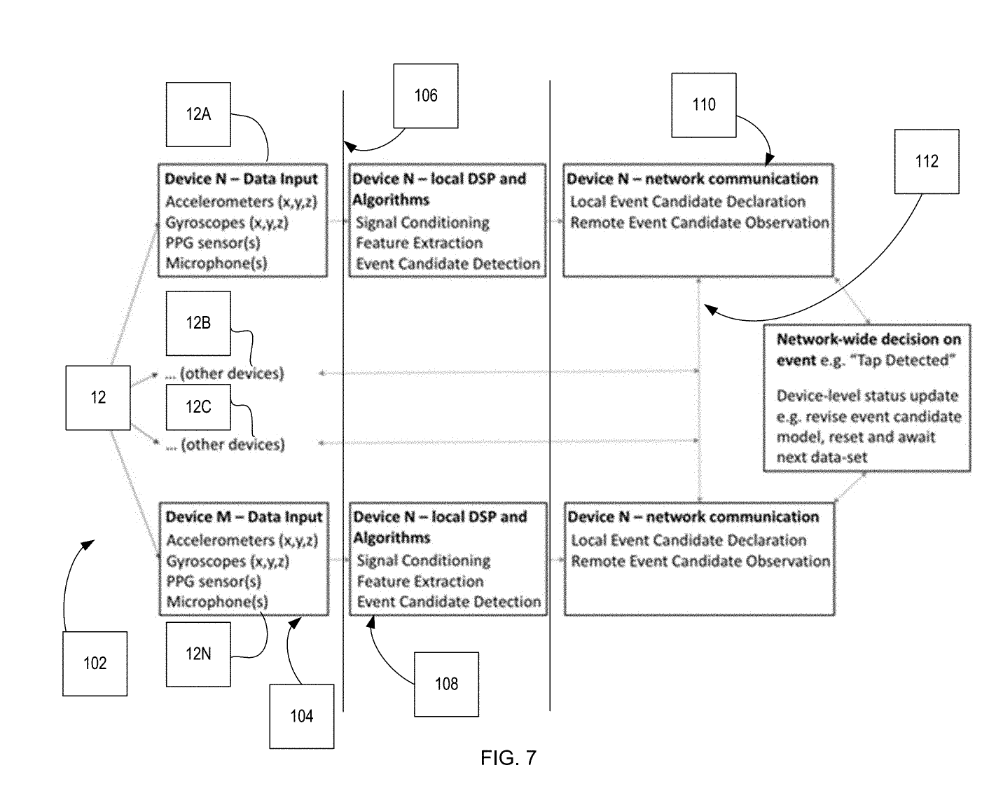

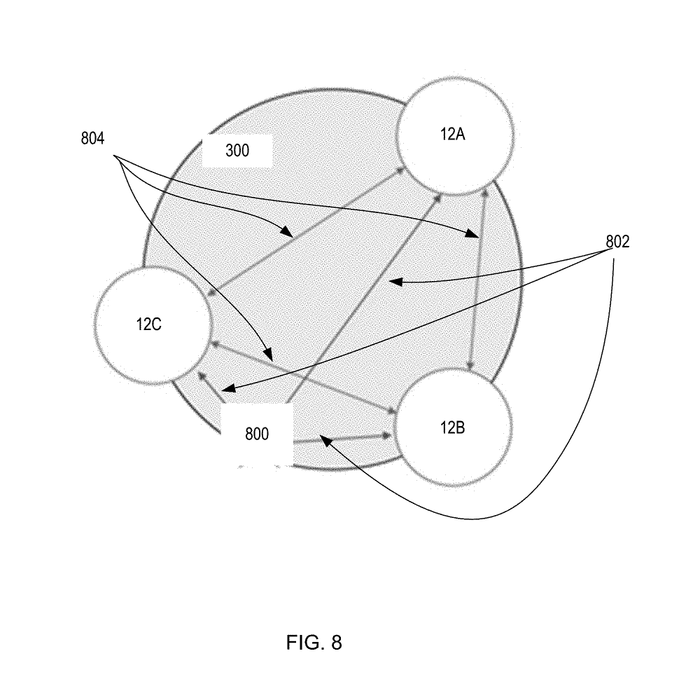

With reference to FIGS. 7 and 8, a discussion of an embodiment of operation for a BAN with a KUI is presented. The use of the body area network 300 (BAN) enables a KUI functionality. The combined wearable electronic devices 12 can for a network 300 to effectively rule-out false positives indicators provided by a user during a KUA, which is extremely difficult or impossible to reject with a single device as it is extremely difficult to determine a false positive from a true positive indicator of a KUA, when the KUA occurs remotely from the wearable electronic device 12A-C. For example, when walking, the foot will strike the floor, ground and/or pavement and provide an event excitation 800 to the user and the wearable electronic devices 12A-C. The event excitation 800 of each wearable device 12A-C will be marginally different than when excited deliberately (e.g., a true KUA such as, a user tapping the skin adjacent to a wearable electronic device 12A). With a BAN 300 the wearable electronic device 12A-C can collaboratively check and compare to what extent other wearable electronic devices 12A-C also detected an event excitation 800, and from this deduce the locality of said event excitation 800 and to which a purpose or a KUA can be attributed.

Excitation event lines 802 represent the energy of the event traveling to the wearable electronic devices 12A-C where each wearable electronic device 12A-C will detect the excitation event 800 and based upon this detection and communication with other wearable electronic device 12A-C through communication lines 804. The energy from event excitation can take many forms as touched on briefly above with discussion to the sensors 16 used. From FIG. 8, it can be shown if wearable electronics device 12A were the only wearable electronic device 12 worn by a user, the detection and proper evaluation of excitation event 800 would be difficult. First, there is a large distance between excitation event 800 and wearable electronic device 12A, therefore, degradation in the strength of the signal of excitation event 800 and any possible noise cause by other excitation events occurring on the user, such as noise, would make it difficult for the wearable electronics device 12A to make an accurate determination as to whether excitation event 800 was a normal body function, such as a foot hitting the pavement while running, or if the user performed a KUA with his foot, such as tapping his foot, to indicate he wanted wearable electronic device 12A to perform a certain function, such as play music.

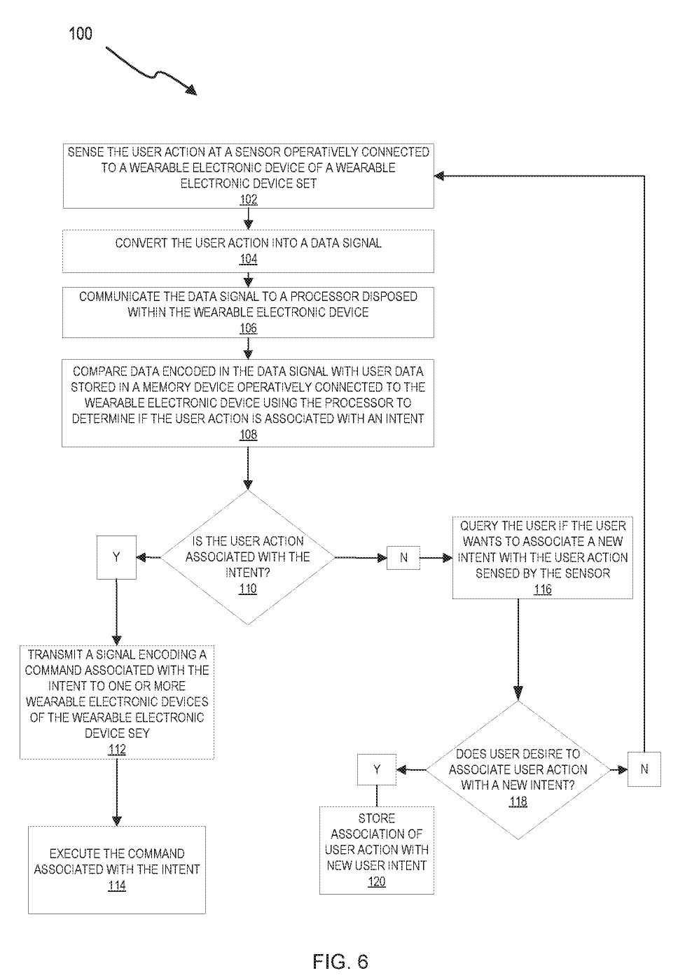

BAN 300 allows a user to utilize any number of wearable electronic devices 12, from 2 to N, where is greater than 1. The use of N wearable electronic devices 12, attached to a body, capable of detecting excitation events 800 and communicating with one another through communication lines 804 to provide a decentralized user interface with a wearable electronic device 12. One such BAN 300 environment of an embodiment of the present invention could be two ear-worn wireless earpieces 50A-B capable of communicating with one another. In another embodiment, wireless earpieces 50A-B each contain an algorithm (which can be a different algorithm based upon which wireless earpiece 50A-B the algorithm was located) which processes the excitation event 800 received by on-board sensors 16. This algorithm, discussed in more detail with reference to FIG. 6, reports the likelihood the user has tapped their temple (an excitation event 800), triggering a detectable signal in the inertial sensor data a KUA has occurred. This likelihood of a ‘local’ event is then declared to the BAN 300, and the wireless earpiece 50A checks for any declarations from elsewhere in the BAN 300 (i.e., from wireless earpiece 50B). Based on the local estimate of the excitation event 800, and any communication lines 804 (from the BAN 300) indicating a KUA, the wireless earpiece 50A can then decide if the user issued a KUA, or if the excitation event 800 is a false-positive, such as a foot striking the floor while running.

With reference to FIGS. 6 & 7, a further discussion of BAN 300 can be shown in an embodiment having N wearable electronic devices 12, where N is greater than 1. As discussed in great detail above, each wearable electronic device 12, can collect data such as accelerometer data, inertial data, sound data and PPG data. In step 102, a sensor 16 operatively connected to the set of wearable electronic devices 12N senses an excitation event 800 from a user. The sensor 16 may comprise an inertial sensor such as a MEMS gyroscope 42, an electronic accelerometer, or an electronic magnetometer and/or contacts 53 and the wearable electronic device set 12N may include an earpiece, a headset, a mobile device, an eyepiece, a body sensor, or any type of wearable electronic device 12 capable of having a sensor 16.

The excitation event 800 sensed by the sensor 16 may be a one-dimensional, two-dimensional, or three-dimensional positional change of the sensor 16 with respect to time caused by the excitation event 800, a change in blood volume or blood flow, or one or more sounds generated either directly or indirectly by the user. Excitation events 800 sensed by the sensor 16 may include walking, running, jogging, touching, tapping, swiping, nodding, head shaking, bowing, kneeling, dance moves, eye blinks, lip movements, mouth movements, facial gestures, shoulder movements, arm movements, hand movements, elbow movements, hip movements, foot movements or any other type of physical movement sensed by a sensor 16. The foregoing list is non-exclusive, and more than one of the aforementioned actions may be combined into a single KUA or the KUA may include more than one excitation event 800.

In step 104, the user action is converted into a data signal. The data signal may comprise a current or current profile, a voltage or voltage profile, or a profile of another physical parameter. In step 106, the data signal is communicated to the processor 20 disposed within one of the wearable electronic devices 12. The data signal may be communicated continuously or discretely, and may be initially communicated to the transceiver 18 before being subsequently transmitted to the processor 20 via one or more signals encoding data associated with the excitation event 800. In step 108, the processor 20 compares data encoded in the data signal with user data stored in the memory device 24 operatively connected to the wearable electronic device set 12N to determine if the excitation event 800 is associated with an KUA, which is meant to initiate a function and/or action at any one or more of wearable electronic device 12. The comparison may be performed using an algorithm stored in either the memory device 26 or the processor 20. The data encoded in the data signal compared by the algorithm may be a current profile with respect to time, a voltage profile with respect to time, an angular velocity profile with respect to time, an acceleration profile with respect to time, or any other physical quantity capable of being measured by the sensor 16.

The user data may comprise the same sort of data as the data encoded in the data signal. The data encoded in the data signal may be considered substantially similar to the user data if the data encoded in the data signal is anywhere from 50% to 100% similar. In step 110, if the excitation event 800 is associated with the KUA, then in step 112, a signal encoding a command associated with the KUA may be transmitted along communication lines 804 to one or more wearable electronic devices 12 of the wearable electronic device set 12N. For example, the signal may encode instructions each wearable electronic device is to turn off, or the signal may encode the user wants to access the volume controls on one or more of the electronic devices 12, especially if the one or more of the electronic devices 12 are wireless earpieces 50A-B worn by the user.

In step 114, the command associated with the KUA is executed by one or more of the wearable electronic devices 12 irrespective of whether the signal is transmitted to other wearable electronic devices 12. If the excitation event 800 is not associated with a KUA, then in step 116, the user can be queried if the user desires to associate a new KUA with the user action sensed by the sensor 16. The querying may be via an inquiry provided via a speaker or the inquiry may be provided to the mobile device 304 to be answered later. If the user desires to set the sensed excitation event 800 with a KUA, then in step 120, data comprising the association of the excitation event 800 with the new KUA is stored in the memory device 26 operatively connected to the wearable electronic device set 12N. If not, the sensor 16 continues to sense potential excitation events 800.

Thus, through the use of N devices 12N, attached to a body and capable of detecting physical phenomena and communicating between one another, a BAN 300 is provided. The BAN 300 may be two wireless earpieces 50A-B capable of communicating with one another. The kinetic user interface may be used where a plurality of devices 12N are present. For example, wireless earpieces 50A-B may each contain an algorithm (not necessarily the same algorithm) which process the data from the sensors 16. This algorithm may report the likelihood the user has tapped their temple (a KUA), triggering a detectable signal in the sensor 16. This likelihood of a KUA is then declared to the BAN 300, and the wearable electronic device 12 checks for any declarations from elsewhere in the BAN 300. Based on the local estimate of a KUA event, and any remote (from the BAN 300) estimates of a KUA, the local wearable electronic device 12 can then decide if the user issued a KUA, or if the detected signal is just a normal excitation event 800, such as a foot striking the floor while running. The use of a body area network (BAN) enables a KUI to exists, because the combined sensor network can effectively rule-out false positives difficult or impossible to reject with a single device. For example, when walking foot strikes provide an impulsive excitation of the vibration system is the user and the worn-device(s). The vibrational response of these systems will be marginally different than when excited deliberately (e.g. a user tapping the skin adjacent to a device). With a BAN the devices can collaboratively check to what extent other devices also detected an event, and from this deduce the locality of said event, to which a purpose can be attributed.

The invention is not to be limited to the particular embodiments described herein. In particular, the invention contemplates numerous variations. The foregoing description has been presented for purposes of illustration and description. It is not intended to be an exhaustive list or limit any of the invention to the precise forms disclosed. It is contemplated other alternatives or exemplary aspects are considered included in the invention. The description is merely examples of embodiments, processes or methods of the invention. It is understood any other modifications, substitutions, and/or additions can be made, which are within the intended spirit and scope of the invention.

What is claimed is:

1. A body area network, comprising:
a plurality of wearable electronic devices, comprising:
a housing;
a sensor operatively connected to the housing, wherein the sensor is configured to sense an excitation event; and
a transceiver operatively connected to the sensor, wherein the transceiver is configured to receive a data signal encoding the excitation event from the sensor and transmit the data signal to a second transceiver disposed within a second wearable electronic device;
a processor disposed within the housing of at least one of the wearable electronic devices is configured to determine a kinetic user action associated with the excitation event from the data signal encoding of the excitation event.

2. The body area network of claim 1, further comprising a mobile device operatively coupled to at least one of the plurality of wearable electronic devices.

3. The body area network of claim 2, further comprising a data service operatively coupled to the mobile device.

4. The body area network of claim 3, further comprising a network operatively coupled to the mobile device and the data service.

5. The body area network of claim 1, wherein each wearable electronic device communicates through the transceiver to at least one of the plurality of wearable electronic devices.

6. The body area network of claim 1, wherein wearable electronic device is a wireless earpiece.

7. The body area network of claim 6, wherein a memory device is operatively connected to the processor and can store the associated kinetic user action.

8. The body area network of claim 7, wherein the processor executes a function associated with the kinetic user action.

9. At least two wearable electronic devices, comprising:
a housing;
a sensor operatively connected to the housing, wherein the sensor is configured to sense an excitation event and convert the excitation event into a data signal;
a transceiver operatively connected to the sensor, wherein the transceiver is configured to transmit or receive the data signal; and
a processor disposed operatively coupled to the transceiver, wherein the processor is programmed to determine whether a kinetic user action occurred based upon the data signals.

10. The at least two wearable electronic devices of claim 9, wherein at least one wearable device is a wireless earpiece.

11. The at least two wearable electronic devices of claim 9 wherein a first wearable device transmits through the transceiver the determination of whether a kinetic user action occurred to a second wearable device.

12. The at least two wearable electronic devices of claim 11, wherein the processor bases the determination of whether a kinetic user action occurred upon the data received from the sensors of the first wearable device and the second wearable device.

13. The at least two wearable electronic devices of claim 12, further comprising a memory device storing an algorithm used by the processor to determine whether the kinetic user action occurred.

14. The at least two wearable electronic devices of claim 13 wherein a user can assign and store in the memory the excitation event to the kinetic user action.

15. The at least two wearable electronic devices of claim 14, wherein the processor executes a function associated with the kinetic user action.

16. A method for creating a body area network, comprising the steps of:
sensing an excitation event at a sensor operatively connected to a plurality of wearable electronic devices;
converting the excitation event into a data signal;
communicating the data signal to a processor disposed within the plurality of wearable electronic devices;
comparing data encoded in the data signal with user data stored in a memory device operatively connected to the plurality of wearable electronic devices using the processor to determine if the excitation event is associated with a kinetic user action; and
executing a command associated with the kinetic user action if the excitation event is determined by the processor to be the kinetic user action.

17. The method of claim 16, further comprising transmitting a signal encoding a command associated with the kinetic user action to at least one wearable electronic device via a transceiver operatively connected to the plurality of wearable electronic devices if the processor determines from the comparison the excitation event is associated with the kinetic user action.

18. The method of claim 16, further comprising storing the data encoded in the data signal in the memory device if the data associated with the excitation event is associated with a kinetic user action by a user.

19. The method of claim 18, further comprising querying a user if the data encoded in the data signal is associated with the kinetic user action.

20. The method of claim 16, further comprising modifying a functionality of the set of wearable devices in response to the signal encoding the command associated with the kinetic user action.
